(19) United States
(12) Patent Application Publication
(10) Pub. No.: US 2013/0145209 A1
(43) Pub. Date: Jun. 6, 2013

(54) DISK SYSTEM, DATA RETAINING DEVICE, AND DISK DEVICE

(71) Applicant: Buffalo Inc., Aichi (JP)

(72) Inventor: SHINSUKE SAITO, Aichi (JP)

(73) Assignee: BUFFALO INC., Aichi (JP)

(21) Appl. No.: 13/652,966

(22) Filed: Oct. 16, 2012

(30) Foreign Application Priority Data
Dec. 5, 2011 (JP) 2011-266078

(51) Int. Cl. G06F 11/20

(52) U.S. Cl. 714/6.32; 714/E11.084

(57) ABSTRACT

An information processing apparatus that detects a failure of one of a plurality of disk drives included within a data array of the information processing apparatus; transmits an inquiry to another information processing apparatus regarding a presence of a spare disk drive having a same capacity as the one of the plurality of disk drives in which a failure is detected; receives, from the another information processing apparatus, information corresponding to a spare disk drive having the same capacity as the one of the plurality of disk drives in which a failure is detected; and mounts the spare disk drive as a substitute for the one of the plurality of disk drives in which the failure is detected.

### CROSS REFERENCE TO RELATED APPLICATION

The present application claims priority to Japanese Patent Application No. 2011-266078 filed on Dec. 5, 2011, the disclosure of which is hereby incorporated by reference in its entirety.

### FIELD OF THE INVENTION

The present disclosure relates to a disk system, a data retaining device included in the same, and a disk device included in the same.

### RELATED ARTS

As digital data has grown in importance, data protection in a phase of a failure of an apparatus has become an important matter. Under such a background, a disk system called Redundant Arrays of Inexpensive Disks (RAID) is being studied for a method which composes a data retaining system having redundancy by using plural disk devices. This type of disk device, for example, is described in Non-Patent Document (Patterson, David, Garth A. Gibson, Randy Katz (1998). “A Case for Redundant Arrays of Inexpensive Disks (RAID).” SIGMOD Conference. pp. 109 to 116.)

As exemplified in FIG. 7, this disk system basically includes a disk controller 11′ and plural (n) disk drives 12′a, 12′b, . . . , 12′n. An operation when a technique called a RAID level 5 (hereinafter referred to as “a RAID 5” for short), for example, is utilized in the disk system is described as follows.

The disk controller 11′ receives data becoming an object of writing, and divides the data thus received into data blocks. Also, the disk controller 11′ arithmetically operates a parity every (n−1) data blocks obtained through the division, and generates at least one set of (n−1) data blocks and the parity. Also, the disk controller 11′ distributes a set(s) of (n−1) data blocks and the parity to n disk devices to be written to the n disk devices. In this case, the disk device which stores therein the parity is switched from the disk drive 12′a up to the disk drive 12′n in order every set of (n−1) data blocks and parity.

By carrying out such an operation, even if one disk drive 12′x is out of order, the original data block can be recreated from either the data block or the parity stored in another disk drive. In addition, the set of (n−1) data blocks and the parity can be recreated from the original data block or the parity thus recreated (reconfiguring of RAID).

For example, a device related to a technique disclosed in Patent Document of Japanese Patent Laid-Open No. 2005-293547 includes plural disk units. Each of the disk units includes plural disk drives, and the RAID is composed of these disk drives. Here, when a failure has been caused in any of the disk drives, the disk drive in which the failure concerned has been caused is set as a failure drive, and a unit ID retrieves a drive becoming spare one from a unit different from the failure drive. If the drive becoming spare one has been retrieved, then, the data reconfiguring of the RAID group is carried out in background processing. This technique described above is disclosed in Patent Document of Japanese Patent Laid-Open No. 2005-293547.

However, although in the case of the device described above, it is not always true that in the disk device set as the spare one, the normal drive cannot be necessarily substituted for the failure drive, any of the conditions about the substitutability is not taken into consideration. Otherwise stated, the unit needs to be configured under a condition such that the disk devices included in the disk unit can naturally act as the spares. Such a condition cannot be readily fulfilled in the actual operation.

The present disclosure has been made in the light of the actual condition described above, and it is therefore a one of the objects of the present disclosure to provide a disk system which is suitable for an actual operation, and which is capable of enhancing availability, a data retaining device included in the same, and a disk device included in the same.

### SUMMARY

According to an embodiment of the present disclosure, there is provided an information processing apparatus comprising: a data array including a plurality of disk drives; a controller that detects a failure of one of the plurality of disk drives within the data array; and a communication interface that transmits an inquiry to another information processing apparatus about a presence of a spare disk drive having a same capacity as the one of the plurality of disk drives in which a failure is detected, wherein the communication interface receives, from the another information processing apparatus, information corresponding to a spare disk drive having the same capacity as the one of the plurality of disk drives in which a failure is detected, and the controller mounts the spare disk drive as a substitute for the one of the plurality of disk drives in which the failure is detected.

According to another embodiment of the present disclosure, there is provided an information processing apparatus comprising: a spare disk drive; a communication interface that receives, from another information processing apparatus, an inquiry about a presence of the spare disk drive having a same capacity as one of a plurality of disk drives in the another information processing apparatus in which a failure is detected; a controller that retrieves information corresponding to the spare disk drive when the spare disk drive has the same capacity as the one of a plurality of disk drives in which the failure was detected, wherein the communication interface transmits the information corresponding to the spare disk drive to the another information processing apparatus.

According to still another embodiment of the present disclosure, there is provided a method performed by an information processing apparatus, the method comprising: detecting a failure of one of a plurality of disk drives included within a data array of the information processing apparatus; transmitting an inquiry to another information processing apparatus regarding a presence of a spare disk drive having a same capacity as the one of the plurality of disk drives in which a failure is detected; receiving, from the another information processing apparatus, information corresponding to a spare disk drive having the same capacity as the one of the plurality of disk drives in which a failure is detected; and mounting the spare disk drive as a substitute for the one of the plurality of disk drives in which the failure is detected.

According to yet still another embodiment of the present disclosure, there is provided a disk system having a first information processing apparatus and a second information processing apparatus, the first information processing apparatus comprising: a data array including a plurality of disk drives; a first controller that detects a failure of one of the plurality of disk drives within the data array; and a first communication interface that transmits an inquiry to the second information processing apparatus about a presence of a spare disk drive having a same capacity as the one of the plurality of disk drives in which a failure is detected, and the second information processing apparatus comprising: a spare disk drive; a second communication interface that receives, from the first information processing apparatus, an inquiry about a presence of the spare disk drive having a same capacity as one of a plurality of disk drives in the first information processing apparatus in which a failure is detected; a second controller that retrieves information corresponding to the spare disk drive when the spare disk drive has the same capacity as the one of a plurality of disk drives in which the failure was detected, wherein the first communication interface receives, from the second information processing apparatus, information corresponding to a spare disk drive having the same capacity as the one of the plurality of disk drives in which a failure is detected, the second communication interface transmits the information corresponding to the spare disk drive to the first information processing apparatus, and the first controller mounts the spare disk drive as a substitute for the one of the plurality of disk drives in which the failure is detected

### BRIEF DESCRIPTION OF DRAWINGS

FIG. 1 is a block diagram showing a configuration of a disk system according to an aspect of an embodiment of the present disclosure;

FIG. 2 is a functional block diagram showing a configuration of a disk controller of a data array in the disk system according to the aspect of the embodiment of the present disclosure;

FIG. 3 is a functional block diagram showing a configuration of a disk controller of a spare device in the disk system according to the aspect of the embodiment of the present disclosure;

FIG. 4 is an explanatory view showing a situation of storage of data in the data array in the disk system according to the aspect of the embodiment of the present disclosure;

FIG. 5 is a flow chart explaining an operation of the disk system according to the aspect of the embodiment of the present disclosure;

FIG. 6 is a block diagram showing another configuration of the spare device in the disk system according to the aspect of the embodiment of the present disclosure; and

FIG. 7 is a block diagram showing an example of a configuration of a general data array in the related art.

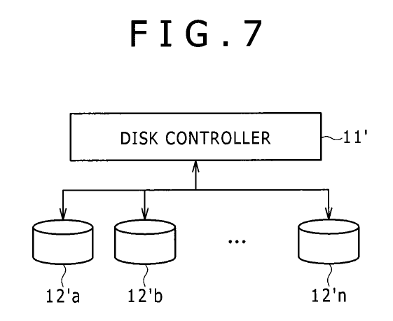

### DESCRIPTION OF THE DISCLOSURE

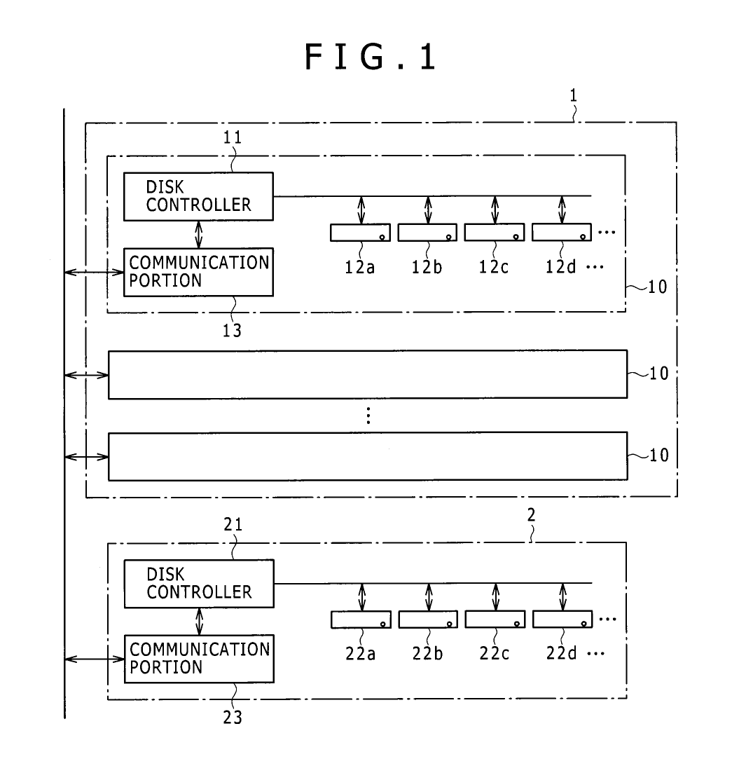

A disk system according to an aspect of an embodiment of the present disclosure, as exemplified in FIG. 1, includes a data retaining device 1 including at least one data array 10, and a spare device 2 including at least one disk drive becoming a spare.

Each of the data arrays 10 of the data retaining device 1 is composed of a disk controller 11, plural (n) disk drives 12a, 12b, . . . , 12n, and a communication portion 13. In addition, the spare device 2 is a disk device and is composed of a disk controller 21, at least one disk drive 22 (a disk drive 22a, a disk drive 22b, . . . , a disk drive 22n when plural disk drives 22 are provided), and a communication portion 23.

For example, as an outline is shown in FIG. 1, the disk drives 12 and the disk drives 22 are each disposed in a line (or may also be each disposed in a matrix of n×m) within a chassis of the data arrays 10 and the spare devises 2.

The disk controller 11 of the data array 10, for example, includes a processor such as a CPU, a memory portion such as a memory device, an I/O controller such as 828011B ICH9 RAID (ICH9R) manufactured by Intel Corporation, and other peripheral circuits (such as a clock generator, a power source manager circuit, and a Universal Serial Bus (USB) interface circuit).

With the disk controller 11, the processor is operated in accordance with a program stored in the memory portion of the disk controller 11, thereby realizing the following functions. That is to say, the disk controller 11 receives a specification of the number of disks configuring an RAID, and a level of the RAID from a user and the RAID is configured in a form thus specified by the plural disk drives 12a, 12b, . . . , 12n. In addition, the disk controller 11 functions to detect a failure of any of the plural disk drives 12a, 12b, . . . , 12n. Also, when the disk controller 11 has detected the failure of any of the plural disk drives 12a, 12b, . . . , 12n, the disk controller 11 inquires the spare device 2, through the communication portion 13, about presence or absence of the disk drive 22 fulfilling a condition such that the disk drive 22 concerned has the same capacity as that of any of the disk drives 12a, 12b, . . . , 12n in which the failure concerned has been detected, and is not currently used. Also, in response to the inquiry concerned, the spare device 2 transmits information on the disk drive 22 fulfilling the condition such that the disk drive 22 concerned has the same capacity as that of the disk drive 12 in which the failure concerned has been detected, and is not currently used to the disk controller 11. When the disk controller 11 receives the information through the communication portion 13, the disk controller 11 mounts the disk drive 22 fulfilling that condition as a substitute for the disk drive 12 in which the failure was detected, and reconfigures the RAID in the form specified by the user. A detailed operation of the disk controller 11 will be described later.

The information is communicated between the data array 10 and the spare device 2 through the communication portion 13. A concrete configuration of the communication portion 13 differs depending on how the data array 10 and the spare device 2 are disposed. However, for example, when the data array 10 and the spare device 2 are accommodated in the same server rack, the communication portion 13 may also be composed of a USB interface. In addition, when the data array 10 and the spare device 2 are connected to each other through a network communication line such as the Internet, the communication portion 13 may also be composed of a network card. In any case, the contents of the communication may be contents of a communication complying with a Small Computer System Interface (SCSI). It is noted that a method of carrying out a communication complying with SCSI through a network, for example, includes an iSCSI (RFC3720 and others). When the iSCSI is utilized, the disk controller 11 on the data array 10 side is operated as an initiator.

Although the spare device 2 has the same configuration as that of the data array 10, the operation of the disk controller 21 is different from that of the disk controller 11 of the data array 10. That is to say, the disk controller 21 also, for example, includes the processor such as the CPU, the memory portion such as the memory device, the I/O controller such as 828011B ICH9 RAID (ICH9R) manufactured by Intel Corporation, and other peripheral circuits (such as the clock generator, the power source manager circuit, and the USB interface circuit).

In the disk controller 21 as well, the processor is operated in accordance with a program stored in the memory portion of the disk controller 21. Also, the disk controller 21 receives an inquiry about presence or absence of the disk drive 22 fulfilling a condition such that the disk drive 22 concerned has the same capacity as that of the disk drive 12 in which a failure has been detected, and is not currently used from any of the plural data arrays 10 included in the data retaining device 1 through the communication portion 23. In response to the inquiry concerned, the disk controller 21 retrieves the disk drive 22 fulfilling the condition thus received of the plural (n) disk drives 22a, 22b, . . . , 22n each adapted to become a spare.

When the disk controller 21 finds out the disk drive 22 fulfilling the condition thus received, the disk controller 21 transmits information used to mount the disk drive 22 thus found out to the data array 10 of the data retaining device 1 of an inquiry source. An operation of the disk controller 21 will also be described later in detail. It is noted that when the iSCSI is utilized, the disk controller 21 is operated as a target.

The communication portion 23 communicates information with the data array 10. Similarly to the case of the communication portion 13 of the data array 10, a concrete configuration of the communication portion 23 can also be suitably composed of the USB interface, a network interface or the like depending on how the data array 10 and the spare device 2 are disposed.

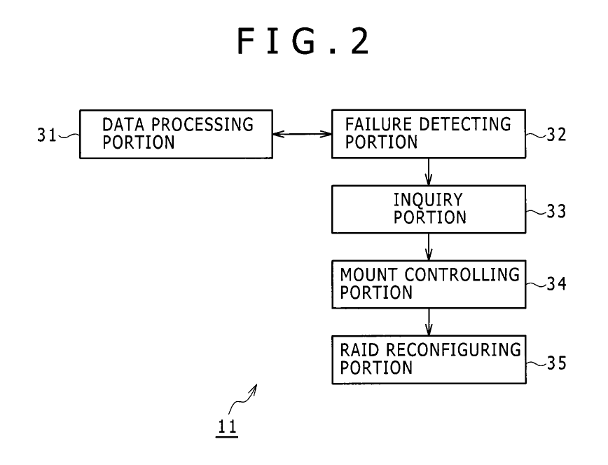

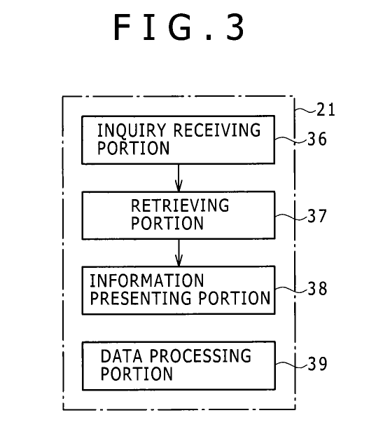

Here, an operation of the disk controller 11 of the data array 10, and an operation of the disk controller 21 of the spare device 2 will be described. As exemplified in FIG. 2, the disk controller 11 of the data array 10 functionally includes a data processing portion 31, a failure detecting portion 32, an inquiry portion 33, a mount controlling portion 34, and an RAID reconfiguring portion 35. In addition, as exemplified in FIG. 3, the disk controller 21 functionally includes an inquiry receiving portion 36, a retrieving portion 37, an information presenting portion 38, and a data processing portion 39.

The data processing portion 31 of the disk controller 11 of each of the data arrays 10 accesses the disk drives 12a, 12b, . . . , 12n configuring the RAID in accordance with an instruction issued from a user, and executes processing for reading out/writing data from/to the disk drives 12a, 12b, . . . , 12n.

The failure detecting portion 32 checks success and failure of the processing for writing data to the disk drives 12 by the data processing portion 31 or the processing for reading out data from the disk drives 12 by the data processing portion 31. When the failure detecting portion 32 detects that the data processing portion 31 fails to execute the processing for writing the data to any of the disk drives 12a, 12b, . . . , 12n or the processing for reading out the data from any of the disk drives 12a, 12b, . . . , 12n, the failure detecting portion 32 outputs information (failure notification information) representing that the disk drive 12 to or from which the data processing portion 31 fails to execute the processing for writing the data or the processing for reading out the data has got out of order. In addition, at this time, the failure detecting portion 32, for example, may notify the user of the failure either by sounding a buzzer or by flicking an LED (light emitting diode) device.

When the failure detecting portion 32 has outputted the failure notification information, the inquiry portion 33 specifies the disk drive 12 that is out of order as a failure drive by referring to the failure notification information concerned. The inquiry portion 33 acquires information representing the capacity of the failure drive. As an example, the inquiry portion 33 transmits a signal used to inquire the failure drive about configuration information to the failure drive. When the failure drive side transmits information containing therein a sector size and a maximum sector address in response to this signal, the inquiry portion 33 receives this information from the failure drive, and thus can acquire the capacity of the failure drive by arithmetic operation based on this information from the failure drive.

Also, the inquiry portion 33 sends an inquiry about presence or absence of the unused disk drive 22 together with the information thus acquired on the capacity of the failure drive to the spare device 2 through the communication portion 13. Here, it is supposed that a network address of the spare device 2, an address of the USB, and the like are be previously set.

When the inquiry portion 33 has received the information about the disk drive 22 which fulfills the condition such that the disk drive 22 has the capacity required from the spare device 2, and is not currently used (hereinafter referred to as “the spare drive”), the inquiry portion 33 outputs the information thus received to the mount controlling portion 34. Specifically, the information concerned is information required for mounting the spare drive. Thus, when the iSCSI is utilized, the information concerned corresponds to information used to specify the spare drive as a registration node on the spare device 2 (target).

Note that, when there is no response from the spare device 2 within a predetermined time, or there is not received the information on the spare drive which has the capacity required and is not currently used, the inquiry portion 33 further notifies the user of that there is no spare drive either, for example, by sounding a buzzer or by flicking an LED device.

When the mount controlling portion 34 has received the information required for mounting the spare drive, the mount controlling portion 34 mounts the spare drive on the spare device 2 by utilizing the information concerned. As an example, when the information used to specify the registration node of the spare drive has been inputted as the information required for mount to the mount controlling portion 34 by utilizing iSCSI, the mount controlling portion 34 executes processing for mounting the registration node concerned.

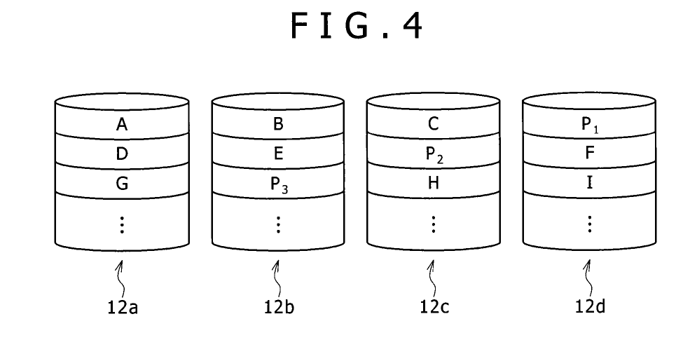

The RAID reconfiguring portion 35 utilizes the spare drive as the substitute for the failure drive, and recreates and writes the information recorded in the failure drive to the spare drive. As an example, it is supposed that at first, the operation in the RAID 5 is carried out utilizing the four disk drives 12a, 12b, 12c, and 12d. In this case, as exemplified in FIG. 4, the data is retained in such a way that data blocks A, D, and G are recorded in the disk drive 12a, data blocks B and E, and a parity P₃ related to data blocks G, H, and I are recorded in the disk drive 12b, and so forth. Here, when the disk drive 12b gets out of order to become the failure drive, the RAID reconfiguring portion 35 recreates data of the data block B based on the data blocks A and C, and a parity P₁ which are stored in the disk drives 12a, 12c, and 12d, respectively, thereby storing the data thus recreated in the disk drive 22 of the spare device 2 mounted as the spare drive. Also, the RAID reconfiguring portion 35 recreates a data block E and a parity P₃ which were stored in the failure drive based on the information stored in other disk drives 12a, 12c, and 12d, thereby storing the data block E and the parity P₃ thus recreated in the spare drive thus mounted.

As a result, the RAID reconfiguring portion 35 configures the RAID 5 composed of the disk drives 12a, 12c, and 12d, and the spare drive. After that, the disk controller 11 continuously carries out the operation in the RAID 5 composed of the disk drives 12a, 12c, and 12d, and the spare drive until, for example, the user repairs the disk drive 12b or a new disk drive is substituted for the disk drive 12b, so that the failure drive within the data array 10 concerned is returned back to a normal state.

When the disk controller 11 has detected that, for example, the user had repaired the disk drive 12b or another disk drive had been substituted for the disk drive 12b to return the failure drive within the data array 10 concerned back to the normal state (alternatively, the disk controller 11 may have detected that the user had depressed a return button), the disk controller 11 copies the data within the spare drive to the disk drive 12 (the disk drive 12b in the case described above) which has been returned back to the normal state, and thus unmounts the spare drive. After that, the disk controller 11 returns back to the RAID configuration composed of the disk drives 12a, 12b, . . . , 12n within the data array 10, and continuously execute the processing for writing/reading out the data.

In addition, the user may continuously carry out the operation in such a way that during maintenance and inspection, or the like, the user draws out the disk drive 22 becoming the spare drive from the spare device 2 to physically substitute the disk drive 22 becoming the spare drive thus drawn out for the failure drive of the data array 10. In this case, the disk controller 21 on the spare device 2 side carries out the setting in such a way that in the phase of unmount as well, the disk drive 22 is not formatted.

In this case, when the disk controller 11 has detected that the failure drive had been returned back to the normal state (alternatively, the disk controller 11 may have detected that the user had depressed the return button), the disk controller 11 utilizes directly the disk drive 22 becoming the spare drive as the substitute for the disk drive 12b which had got out of order (as a new disk drive 12b) to return back to the RAID configuration composed of the disk drives 12a, 12b, 12c, and 12d within the data array 10. In this state, the disk controller 11 continuously executes the processing for writing/reading out the data.

On the other hand, the inquiry receiving portion 36 of the disk controller 21 on the spare device 2 side receives an inquiry about presence or absence of the disk drive 22 fulfilling the condition such that, for example, the disk drive 22 has the same capacity as that of the failure drive, and is not currently used, from any one of the data arrays 10 through the communication portion 23. Also, the inquiry receiving portion 36 outputs the information on a condition contained in the inquiry thus received to the retrieving portion 37.

Then, the retrieving portion 37 receives the information on the condition concerned. Also, the retrieving portion 37 retrieves the disk drive 22, fulfilling the condition thus received, of the n disk drives 22a, 22b, . . . , 22n within the spare device 2. As an example, since the information on the capacity of the failure drive is contained in the condition described herein, the retrieving portion 37 retrieves the disk drive 22 which has the same capacity as that represented by the information concerned, and is not currently utilized (which is mounted from none of the associated portions). When the retrieving portion 37 has found out the disk drive 22 fulfilling the condition thus received, the retrieving portion 37 outputs information used to specify the disk drive 22 thus found out to the information presenting portion 38. On the other hand, when the retrieving portion 37 has been unable to find out the disk drive 22 fulfilling the condition thus received, the retrieving portion 37 may determine that this processing is an error, and then ends the processing.

The information presenting portion 38 receives the information used to specify the disk drive 22 which has been found out by the retrieving portion 37 from the retrieving portion 37. Also, the information presenting portion 38 generates information required for mounting the disk drive 22 specified by the information concerned on the data array 10 side. The information presenting portion 38 sends the information thus generated for the data array 10 as a transmission source of the inquiry received by the inquiry receiving portion 36.

For example, while the iSCSI is utilized, the information presenting portion 38 defines the disk drive 22 found out by the retrieving portion 37 as a target. During this definition, the information presenting portion 38 sets a specific name (target name) to the disk drive 22 concerned. Also, the information presenting portion 38 sends information on the target name thus set as the information required for mount for the data array 10 as the transmission source of the inquiry. It is noted that other necessary settings such as registration in an access control list shall be carried out.

In accordance with an instruction to read out/write the data which has been received from the data array 10 becoming a mount destination of the disk drive 22, the data processing portion 39 accesses the disk drives 22a, 22b, 22n, and executes the processing for reading out/writing the data.

In addition, when the disk drive 22 has been unmounted from the data array 10, the data processing portion 39 may format the disk drive 22 thus unmounted to set a state of the disk drive 22 as an unused state.

The disk system according to the aspect of the embodiment of the present disclosure has the above configuration and is operated as follows. Specifically, in the following case, it is supposed that N data arrays 10 included in the disk system are all rack mount type devices. Also, it is supposed that a rack in which N data arrays 10 are disposed is formed in the disk system. In addition, in the following case, it is supposed that the spare device 2 is also a device having the same configuration as that of the data array 10, incorporated together with the data arrays 10 in the same rack, and connected through a communication interface such as the USB or the network.

In addition, in this case, it is supposed that in a part of the data arrays 10, the number of disk drives 12 built therein is four, and the capacities thereof are each 1TB. Also, it is supposed that in other data arrays 10, the number of disk drives 12 built therein is four, and the capacities thereof are each 2TB. Also, it is supposed that in the spare device 2, each of the two disk drives 22a and 22b has the capacity of 1TB, each of the two disk drives 22c and 22d has the capacity of 2TB, and any of the disk drives 22a, 22b, 22c, and 22d is at first unused. In addition, in the following case, it is supposed that in each of the data arrays 10, the RAID 5 is configured.

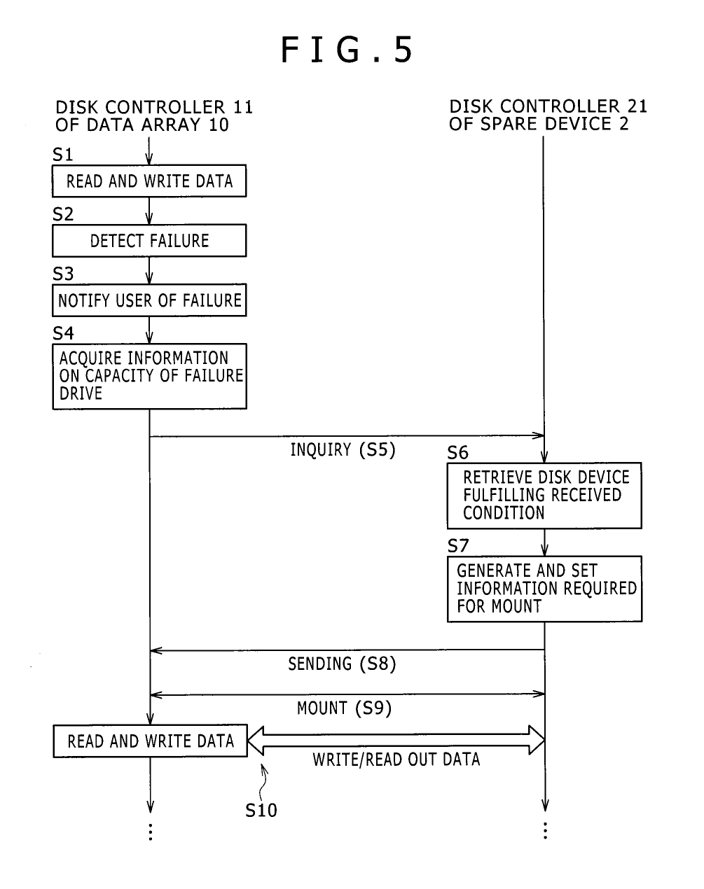

As shown in FIG. 5, at first, the disk controller 11 of each of the data arrays 10 accesses the disk drives 12a, 12b, 12c, and 12d configuring the RAID to execute the processing for reading out/writing the data in accordance with an instruction issued from the user (Step S1).

Here, when the disk drive 12b has got out of order in one of the data arrays 10 (it is supposed that the disk drives 12 has the capacity of 1 TB), the disk controller 11 of the data array 10 concerned detects an access failure to the disk drive 12b (failure drive) (Step S2), and then outputs failure notification information (Step S3). The disk controller 11 acquires information representing the capacity of the failure drive (Step S4). In this case, the disk controller 11 acquires the information of “1 TB.”

The disk controller 11 sends an inquiry about presence or absence of the unused disk drive 22 together with the information on the capacity of the failure drive (“1TB”) which has been acquired, to the spare device 2 through the communication portion 13 (Step S5).

The disk controller 21 on the spare device 2 side receives an inquiry about presence or absence of the disk drive 22 fulfilling the condition such that the disk drive 22 has the same capacity as that of the failure drive, and is not currently used, together with the information on the capacity of the failure drive from the data array 10 including the failure drive concerned through the communication portion 23.

The disk controller 21 of the spare device 2 retrieves the disk drive 22, fulfilling the condition thus received, of the disc drives 22 built in the spare device 2 (Step S6). In this case, since the disk controller 21 of the spare device 2 retrieves the unused disk having the capacity of “1TB,” the disk controller 21 finds out the disk drive 22a.

The disk controller 21 generates information required for mounting the disk drive 22a thus found out on the data array 10 side (Step S7). Specifically, in order that the disk drive 22a may be mounted so as to be compliant with the iSCSI, the disk controller 21 carries out the definition in terms of the target and, for example, sets a name such as spare_{—}1tb.no1.com.foo.bar. Also, the disk controller 21 sends information, required for mount, such as the name thus set to the data array 10 side as a transmission source of the inquiry (Step S8). It is noted that other necessary settings such as the registration to the access control list are specially carried out.

When the disk controller 11 of the data array 10 including the failure drive has received the information required for mount, the disk controller 11 executes processing for mounting the disk drive 22a of the target represented by the information concerned as the spare drive (Step S9). Specifically, as described above, the disk controller 11 executes login processing for the target (registration node) of a name defined on the disk controller 21 side as processing on the initiator side of the iSCSI by using the name concerned.

The disk controller 11 recreates and writes the information recorded in the failure drive to the spare drive by utilizing the spare drive as the substitute for the failure drive, thereby reconfiguring the RAID 5 (Step S10). At this time, the operation for writing the data to the spare drive, and the operation for reading out the data from the spare drive are performed by issuing an instruction to the disk controller 21 on the spare device 2 side through the communication portion 13 and the communication portion 23. That is to say, the disk controller 21 accesses the disk drives 22 to carry out the operation for reading out/writing the data in accordance with an instruction to read out/write the data which is received from the data array 10 becoming the mount destination.

As a result, it becomes possible on the data array 10 side to continuously carry out the operation while the RAID configuration is maintained. In addition, in this embodiment, the utilization efficiency of the disk drives can be enhanced as compared with the case where the spares are provided in the data arrays 10, respectively, so as to show one-to-one correspondence because it is only necessary that the spare device 2 is suitably provided so as to correspond to a failure rate.

Note that, in this case, a method in which, for example, in the case where of the disk drives 22 built in the spare device 2, plural disk drives 22 each fulfilling the received condition exist, the disk controller 21 selects which of the disk drives 22 is set as the spare drive is not especially determined. Thus, although what number disk drive 22 may be set as the spare drive as long as the condition concerned is fulfilled, the following method may be adopted.

That is to say, during the inquiry, the disk controller 11 of the data array 10 including the failure drive transmits information representing what number disk drive is the failure drive (disk order information) of the disk drives 12 within the data arrays 10, to the spare device 2 side. In the spare device 2, the disk drives 22 each fulfilling the condition related to the inquiry are retrieved. Also, it is determined whether or not the disk drive located in the position represented by the disk order information transmitted exists within the disk drives 22 found out by the retrieval. If it is determined that such a disk drive exists, even when in addition to such a disk drive, the disk drive fulfilling the condition concerned exists, information used to mount the disk drive located in the position represented by the disk order information transmitted may be transmitted to the data array 10 side.

By carrying out such an operation, if the disk drive 22 becoming the spare drive is drawn from the spare device 2 to be physically substituted for the failure drive of the data array 10, thereby continuously carrying out the operation (as previously stated, in this case, the setting is carried out in such a way that the disk drive 22 is not formatted in the phase of the unmount as well), then, there is an advantage that the work becomes easily understandable for the user because the position of the disk drive 22 thus drawn out becomes identical to the position of the failure drive becoming an object of the substitution as much as possible.

In addition, in the aspect of the embodiment of the present disclosure, as previously stated, the data array 10 and the spare device 2 may be communicatably connected to each other through the network communication line such as the Internet. When the spare device 2 can be remotely disposed in such a way, the service in which plural devices each functioning as the spare device 2 are disposed and the spare device 2 is caused to be utilized may also be presented.

When the spare device 2 is remotely disposed in such a manner, on the spare device 2 side, two or more disk drives 22 each becoming the spare drive may be used, and the operation for writing the data may be mirrored. In a word, in this case, in the processing in Step S6 shown in FIG. 5, the disk controller 21 of the spare device 2 retrieves plural disk drives 22, each fulfilling the received condition, of the disk drives 22 built in the spare device 2.

Since in the above case, the unused disk having the capacity of 1 TB is retrieved, the disk controller 21 finds out both of the disk drive 22a and the disk drive 22b.

Also, in the processing in Step S7 shown in FIG. 5, the disk controller 21 uses both of the disk drive 22a and the disk drive 22b thus found out in the form of the mirroring. Thus, the logical disk drive having the same capacity as that of either the disk drive 22a or the disk drive 22b is formed, and the information required for mounting the logical disk drive on the data array 10 side is generated. Since the formation of the logical disk drive, and the like are generally known, a detailed description thereof is omitted here for the sake of simplicity.

When the disk controller 11 on the data array 10 side mounts the logical disk drive not only as the substitute for the failure drive, but also as the spare drive, subsequently, the disk controller 21 carries out the operation for writing the same data to both of the disk drive 22a and the disk drive 22b in accordance with an instruction to write the data to the spare drive concerned (mirroring).

After that, in a stage in which the operation becomes able to be temporarily stopped, the disk controller 21 is instructed to stop the control for the mirroring. When the disk controller 21 stops the control for the mirroring in accordance with this instruction, a manager of the spare device 2 detaches one of the disk drive 22a and the disk drive 22b from the spare device 2, and delivers the disk drive 22 thus detached to a side of the user of the data array 10 including the failure drive. The user side substitutes the disk drive 22 thus delivered for the failure drive to mount the disk drive 22 to the data array 10, thereby carrying out continuously the operation.

It is noted that when the necessity for the operation occurs during the stop of the operation (during the delivery of the disk drive 22), the above logical disk drive is mounted on the data array 10 side, thereby carrying out continuously the operation. Then, since the disk controller 21 stops the control for the mirroring, the data is written to the disk drive 22 (for example, the disk drive 22a) which is not detached from the spare device 2 in accordance with the instruction, to write the data to the spare drive, issued from the data array 10 side. In addition, the disk controller 21 reads out the data from the disk drive 22 (the disk drive 22a in this case) becoming the writing destination in accordance with the instruction, to read out the data from the spare drive, issued from the data array 10 side, and transmits the data thus read out to the data array 10.

In this case, after the user side substitutes the disk drive 22b thus delivered for the failure drive to mount the disk drive 22b to the data array 10, the user side restores the data from the spare drive which is mounted. In a word, the data is restored from the disk drive 22a to the delivered disk drive 22b. In such a manner, in this embodiment, the operation on the user side can be continuously, readily carried out.

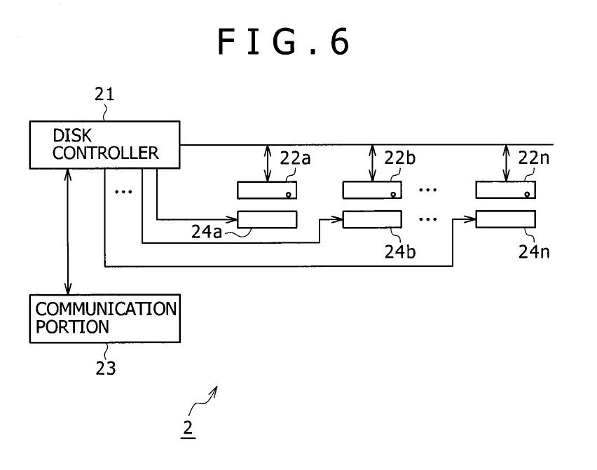

In addition, the spare device 2 in the disk system according to a modified change of the aspect of the embodiment of the present disclosure, as exemplified in FIG. 6, may include display portions 24a, 24b, 24n such as the liquid crystal display devices which are provided so as to correspond to the disk drives 22a, 22b, 22n, respectively. The display portion 24 displays thereon information in accordance with an instruction inputted thereto from the disk controller 21. In another modified change of the aspect of the embodiment, the disk controller 21 displays information on the mount on the display portion 24 corresponding to the disk drive 22 which is mounted to the data array 10.

Here, the information on the mount, for example, includes information (which may be identification information which is previously set every data array 10 or address information such as an IP address) used to specify the data array 10, and a number of a disk drive of a mount destination (corresponding to the information on the position of the failure drive). The display form of the information on the mount, for example, is exemplified by “data array#8 drive#3, RAID being configured.”

In addition, in the description which has been given until now, for the communication portion 13 and the communication portion 23, the communication paths for the control information on the disk drives 22, such as the inquiry about presence or absence of the disk drive 22 which can become the spare drive for the spare device 2 from the data arrays 10, and the response to the inquiry concerned, and for the data which is written to the disk drives 22 or is read out from the disk drives 22 are not especially separated. However, these communication paths may also be individually provided.

For example, a configuration may also be adopted such that each of the communication portion 13 and the communication portion 23 includes two USB ports: a first USB port; and a second USB port, and the control information is communicated between the communication portion 13 and the communication portion 23 through the first USB ports each becoming control information communicating means, and also the data is communicated between the communication portion 13 and the communication portion 23 through the second USB ports each becoming data communicating means. In addition, in the case as well where each of the communication portion 13 and the communication portion 23 is a network interface, similarly, a configuration may also be adopted such that each of the communication portion 13 and the communication portion 23 includes two network interfaces: a first network interface; and a second network interface, and the control information is communicated between the communication portion 13 and the communication portion 23 through the first network interfaces each becoming the control information communicating means, and also the data is communicated between the communication portion 13 and the communication portion 23 through the second network interfaces each becoming the data communicating means.

According to the embodiment of the present disclosure, even in the actual operation environment in which the disk drives different in capacity from one another are interchangeably provided, the suitable disk drive which has the same capacity as that of the failure drive is selected and used as the disk drive becoming the spare, thereby making it possible to enhance the potential of application (availability).

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a data array including a plurality of disk drives;
a controller that detects a failure of one of the plurality of disk drives within the data array; and
a communication interface that transmits an inquiry to another information processing apparatus about a presence of a spare disk drive having a same capacity as the one of the plurality of disk drives in which a failure is detected, wherein
the communication interface receives, from the another information processing apparatus, information corresponding to a spare disk drive having the same capacity as the one of the plurality of disk drives in which a failure is detected, and
the controller mounts the spare disk drive as a substitute for the one of the plurality of disk drives in which the failure is detected.

2. The information processing apparatus of claim 1, further comprising:
a user interface that outputs a notification when the controller detects the failure of the one of the plurality of disk drives within the data array.

3. The information processing apparatus of claim 1, wherein
the controller acquires information indicating the capacity of the one of the plurality of disk drives in which the failure is detected.

4. The information processing apparatus of claim 1, wherein
the information corresponding to the spare disk drive received from the another information processing apparatus includes a name corresponding to the spare disk drive.

5. The information processing apparatus of claim 1, wherein
the controller controls writing data to the spare disk drive upon mounting the spare disk drive.

6. The information processing apparatus of claim 1, wherein
the controller controls reading data from the spare disk drive upon mounting the spare disk drive.

7. An information processing apparatus comprising:
a spare disk drive;
a communication interface that receives, from another information processing apparatus, an inquiry about a presence of the spare disk drive having a same capacity as one of a plurality of disk drives in the another information processing apparatus in which a failure is detected;
a controller that retrieves information corresponding to the spare disk drive when the spare disk drive has the same capacity as the one of a plurality of disk drives in which the failure was detected, wherein
the communication interface transmits the information corresponding to the spare disk drive to the another information processing apparatus.

8. The information processing apparatus of claim 7, wherein
the information corresponding to the spare disk drive includes a name of the spare disk drive.

9. The information processing apparatus of claim 7, further comprising:
a plurality of spare disk drives, wherein
the controller determines that at least two of the plurality of the spare disk drives have the same capacity as the one of a plurality of disk drives in which the failure was detected, and retrieves information corresponding to the at least two of the plurality of the spare disk drives, and
the communication interface transmits the information corresponding to the at least two of the plurality of the spare disk drives to the another information processing apparatus.

10. The information processing apparatus of claim 7, further comprising:
a display that displays information indicating a mount condition of the spare disk drive in relation to the another information processing apparatus.

11. A method performed by an information processing apparatus, the method comprising:
detecting a failure of one of a plurality of disk drives included within a data array of the information processing apparatus;
transmitting an inquiry to another information processing apparatus regarding a presence of a spare disk drive having a same capacity as the one of the plurality of disk drives in which a failure is detected;
receiving, from the another information processing apparatus, information corresponding to a spare disk drive having the same capacity as the one of the plurality of disk drives in which a failure is detected; and
mounting the spare disk drive as a substitute for the one of the plurality of disk drives in which the failure is detected.

12. A disk system having a first information processing apparatus and a second information processing apparatus,
the first information processing apparatus comprising:
a data array including a plurality of disk drives;
a first controller that detects a failure of one of the plurality of disk drives within the data array; and
a first communication interface that transmits an inquiry to the second information processing apparatus about a presence of a spare disk drive having a same capacity as the one of the plurality of disk drives in which a failure is detected,
and the second information processing apparatus comprising:
a spare disk drive;
a second communication interface that receives, from the first information processing apparatus, an inquiry about a presence of the spare disk drive having a same capacity as one of a plurality of disk drives in the first information processing apparatus in which a failure is detected;
a second controller that retrieves information corresponding to the spare disk drive when the spare disk drive has the same capacity as the one of a plurality of disk drives in which the failure was detected,
wherein
the first communication interface receives, from the second information processing apparatus, information corresponding to a spare disk drive having the same capacity as the one of the plurality of disk drives in which a failure is detected,
the second communication interface transmits the information corresponding to the spare disk drive to the first information processing apparatus, and
the first controller mounts the spare disk drive as a substitute for the one of the plurality of disk drives in which the failure is detected.
